(19) United States
(12) Patent Application Publication
(10) Pub. No.: US 2021/0374533 A1
(43) Pub. Date: Dec. 2, 2021

(54) Fully Explainable Document Classification Method And System

(71) Applicant: Dathena Science Pte. Ltd., Singapore (SG)

(72) Inventors: Christopher MUFFAT, Singapore (SG); Tetiana KODLIUK, Singapore (SG); Adel RAHIMI, Singapore (SG)

(73) Assignee: Dathena Science Pte. Ltd., Singapore (SG)

(21) Appl. No.: 17/331,938

(22) Filed: May 27, 2021

(30) Foreign Application Priority Data
May 27, 2020 (SG) 10202004977P

(51) Int. Cl. G06N 3/08; G06K 9/62; G06K 9/00

(52) U.S. Cl. CPC G06N 3/08; G06K 9/00456; G06K 9/6298

(57) ABSTRACT

Methods, systems and computer readable medium for explainable artificial intelligence are provided. The method for explainable artificial intelligence includes receiving a document and pre-processing the document to prepare information in the document for processing. The method further includes processing the information by an artificial neural network for one or more tasks. In addition, the method includes providing explanations and visualization of the processing by the artificial neural network to a user during processing of the information by the artificial neural network.

### PRIORITY CLAIM

This application claims priority from Singapore Patent Application No. 10202004977P filed on May 27, 2020, the entirety of which is hereby incorporated by reference.

### TECHNICAL FIELD

The present disclosure relates generally to explainable artificial intelligence (AI), machine learning, and deep learning in the field of data management, and more particularly relates to fully explainable AI-based document classification methods and systems.

### BACKGROUND OF THE DISCLOSURE

It is undeniable that we are living in the era of Artificial Intelligence (AI) News outlets are talking continuously about an AI revolution, while some public figures such as Andrew Ng—one of the most influential AI gurus—went as far as baptize AI “the new electricity”. But while such praise and recognition dominate the public discourse, dissonant voices have started emerging to mitigate AI's success.

Because of its omnipresence, it is dangerous to let AI slip out of our control. However, it is difficult to understand what happens inside AI models, to understand the AI decision-making process. Without confidence in or transparency of the AI processes, one will find it difficult to trust results of the AI processes.

One way is to provide Explainable AI (XAI) so that a user can view the AI process. However, what does Explainable AI mean? The Merriam-Webster dictionary defines the word explanation as “to make plain or understandable”. According to this definition, an explainable AI should be understandable by the user, which is the opposite of so-called “black-box models” A more philosophical approach to this definition leads us to understand that an explanation relies on a request for understanding. In other words, there should be a request for there to be an explanation.

Most methods previously used for Neural Networks relied on perturbing the input data and measuring the resulting output from the network. Concretely, this means that each feature in the input of the network is changed so much that it does not have any of its original characteristic. Measurement is then made of how important that feature provides to the output of the network Recent methods, on the other hand, measure the sensitivity of the Neural Network to features based on a gradient. However, both of these methods are black-box methods which provide no explainability. When relying on black-box models, the end-user does not understand how the model predicts its output (a specific label in the case of a classification task, or a range in the case of regression problems).

Thus, there is a need for explainable artificial intelligence systems and methods which is adaptable to the vagaries of various artificial intelligent (AI) processes, able to address the above-mentioned shortcomings, and enable the user to build confidence and trust in the operation of the AI processes. Furthermore, other desirable features and characteristics will become apparent from the subsequent detailed description and the appended claims, taken in conjunction with the accompanying drawings and this background of the disclosure.

### SUMMARY

According to at least one embodiment, a system for explainable artificial intelligence is provided. The system includes a document input device, a pre-processing device, an artificial neural network, and a user interface device. The pre-processing device is coupled to the document input device and configured to prepare information in documents for processing and the artificial neural network is coupled to the pre-processing device and configured to process the information for one or more tasks. The user interface device is coupled to the artificial neural network and configured in operation to provide explanations and visualization to a user of the processing by the artificial neural network.

According to another embodiment, a method for explainable artificial intelligence is provided. The method includes receiving a document and pre-processing the document to prepare information in the document for processing. The method further includes processing the information by an artificial neural network for one or more tasks. In addition, the method includes providing explanations and visualization of the processing by the artificial neural network to a user during processing of the information by the artificial neural network.

According to a further embodiment, a computer readable medium having instructions for performing explainable artificial intelligence stored thereon is provided. When providing the instructions to a processor, the instructions when executed by the processor cause the processor to receive a document, process information in the document by an artificial neural network for one or more tasks, and provide explanations and visualization of the processing by the artificial neural network to a user during processing of the information by the artificial neural network.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts an illustration of a conventional neural network.

FIG. 2 depicts a block diagram of a system for artificial intelligence (AI) explainability in accordance with present embodiments.

FIG. 3 depicts a block diagram of a software system for targeted classification including AI explainability in accordance with the present embodiments.

FIG. 4 depicts a block diagram of a pipeline system which incorporates Pipeline classification including AI explainability in accordance with the present embodiments.

FIG. 5 illustrates a user input for standalone targeted classification in accordance with the present embodiments.

FIG. 6 depicts a block diagram for model training and model evaluation in accordance with the present embodiments having a human in the loop.

FIG. 7 depicts a block diagram 700 of an exemplary general architecture of explainable machine learning software in accordance with the present embodiments.

FIG. 8 illustrates a block diagram depicting the general architecture of explainable machine learning software in accordance with the present embodiments with architecture of an exemplary explainable interface.

FIG. 9 illustrates a block diagram depicting the general architecture of explainable machine learning software in accordance with the present embodiments with architecture of an explainable model in accordance with the present embodiments.

FIG. 10, comprising FIGS. 10A and 10B, depicts sampling of first text using one-hot encoding in accordance with the present embodiments, wherein FIG. 10A depicts sampling of words in the first text and FIG. 10B depicts sampling of sentences in the first text.

FIG. 11, comprising FIGS. 11A and 11B, depicts sampling of second text using one-hot encoding in accordance with the present embodiments, wherein FIG. 11A depicts sampling of sentences in the second text and FIG. 11B depicts sampling of phrases in the second text.

FIG. 12, comprising FIGS. 12A and 12B, depicts sampling of a third text using one-hot encoding in accordance with the present embodiments, wherein FIG. 12A depicts sampling of keywords in the third text and FIG. 12B depicts prioritization of the keywords identified in the third text.

FIG. 13 depicts an illustration 1300 of sampling of a fourth text 1305 to identify sentences based on word occurrences using one-hot encoding in accordance with the present embodiments.

FIG. 14, comprising FIGS. 14A and 14B, depicts sampling of a fifth text for text indicative of negative labels using one-hot encoding in accordance with the present embodiments, wherein FIG. 14A depicts sampling of sentences in the fifth text and FIG. 14B depicts sampling of phrases in the fifth text.

FIG. 15 depicts an illustration of the second text sampled by Sent2Vec in accordance with the present embodiments.

FIG. 16 depicts an illustration of the first text sampled by Sent2Vec in accordance with the present embodiments.

FIG. 17, comprising FIGS. 17A and 17B, depict illustrations of a first edge case sampled for sentences in accordance with the present embodiments, wherein FIG. 17A depicts an index number and predicted and correct labels for the first edge case and FIG. 17B depicts text of the first edge case with identified sentences highlighted.

FIG. 18, comprising FIGS. 18A and 18B, depict illustrations of a second edge case sampled for sentences in accordance with the present embodiments, wherein FIG. 18A depicts an index number and predicted and correct labels for the second edge case and FIG. 18B depicts text of the second edge case with identified sentences highlighted.

FIG. 19, comprising FIGS. 19A and 19B, depict illustrations of a third edge case sampled for sentences in accordance with the present embodiments, wherein FIG. 19A depicts an index number and predicted and correct labels for the third edge case and FIG. 19B depicts text of the third edge case with identified sentences highlighted.

FIG. 20, comprising FIGS. 20A to 20D, depict an illustration of exemplary text sampled by Sent2Vec in accordance with the present embodiments, wherein FIG. 20A depicts an index number and predicted and correct labels for the exemplary text without header, footer and quotes, FIG. 20B depicts text of the exemplary text without header, footer and quotes with identified sentences highlighted, FIG. 20C depicts text of the exemplary text with header, footer and quotes and with identified sentences highlighted, and FIG. 20D depicts an index number and predicted and correct labels for the exemplary text with header, footer and quotes.

FIG. 21, comprising FIGS. 21A and 21B, depict an illustration of exemplary text dataset of positive and negative movie reviews from the Cornell Natural Language Processing sampled by Sent2Vec in accordance with present embodiments, wherein FIG. 21A depicts an index number and predicted and correct labels for the exemplary text and FIG. 21B depicts the exemplary text with identified sentences highlighted.

FIG. 22, comprising FIGS. 22A, 22B and 22C, depicts further examination of a first edge case from the dataset of positive and negative movie reviews from the Cornell Natural Language Processing sampled by Sent2Vec in accordance with present embodiments, wherein FIG. 22A depicts an index number and predicted and correct labels for the first edge case, FIG. 22B depicts text of the first edge case, and FIG. 22C depicts prediction of important sentences in the text of the first edge case.

FIG. 23, comprising FIGS. 23A, 23B and 23C, depicts further examination of a second edge case from the dataset of positive and negative movie reviews from the Cornell Natural Language Processing sampled by Sent2Vec in accordance with present embodiments, wherein FIG. 22A depicts an index number and predicted and correct labels for the second edge case, FIG. 23B depicts text of the second edge case with identified sentences highlighted, and FIG. 23C depicts prediction of important sentences in the text of the second edge case.

FIG. 24, comprising FIGS. 24A, 24B and 24C, depict sample explanations of image showing numbers based on measurements of the activation function outputs between two groups in accordance with the present embodiments, wherein FIG. 24A depicts images of the number “9”, FIG. 24B depicts images of the number “7”, and FIG. 24C depicts images of the number “3”.

And FIG. 25 is a bar graph which depicts the number of files in various business categories classified for confidentiality in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is the intent of the present embodiments to present systems and methods for artificial intelligence based document classification using deep learning and machine learning wherein the systems and methods allow a user to access full explanation of the artificial intelligence used.

According to an aspect of the present embodiments, a method for textual data classification by business category and confidentiality level which allows user access to explainable artificial intelligence is provided. The novel explanation technique is used to explain the prediction of any neural network of Natural Language Processing (NLP) and image classification in an interpretable and faithful manner, by calculating the importance of a feature via statistical analysis of the activation function. The method measures how important a feature is with the output of the given networks and may further include generating explanation output visualization based on the behavior of networks.

According to a further aspect of the present embodiments, a system for artificial intelligence explainability is provided which aims to explain and visualize decision-making process of any Artificial Neural Network to give the domain user visibility on the model behavior, enable the domain user to build trust in the artificial intelligence, and comply with regulations regarding “Right of Explainability”. In accordance with the present embodiments, an explainable data classification solution is completely understandable for the end-user. A different kind of expertise comes with the visualization of a meaningful part of the text, which provides reasoning behind the model decisions. The right answers to provide the user desiring AI explainability is to show the user ho % the model's parameters are involved in its decision process, and what these parameters represent. It is also important to give a holistic e-planation by taking multiple parameters together to avoid confusion when separating parameters makes the result unclear to the end-user.

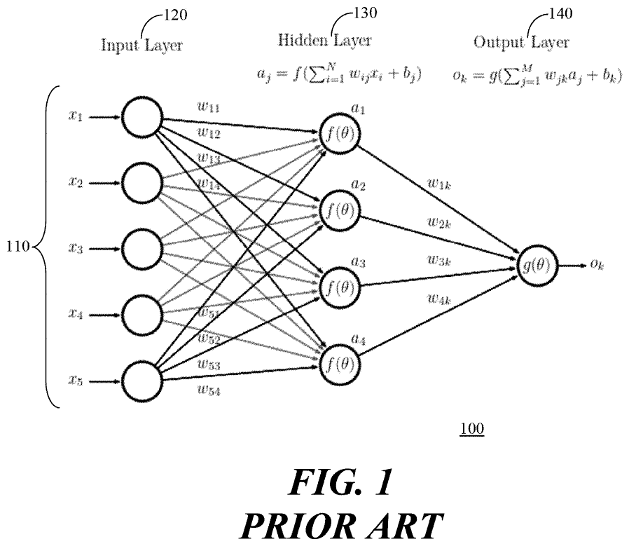

Referring to FIG. 1, an illustration 100 depicts a representation of a conventional neural network 110. The neural network 110 includes an input layer 120, a hidden layer 130, and an output layer 140. The neural network 110 consist of a set of inputs (xᵢ) fed to the input layer 120. A set of weights and biases ((wᵢ,bᵢ)∈ [symbol] ) and a set of non-linear activation functions (e.g. tanh, sigmoid, ReLU, . . . ) are provided to the set of inputs (xᵢ) as the data passes through the hidden layer 130 and to the output layer 140. The collection of weights and biases are called network “parameters”.

The neural network 110 is trained by passing the data (i.e., the set of inputs (xᵢ)) through a first phase known as the “forward” phase. During this phase, the input passes through the network 110 and a prediction is made. Once this is done, the network 110 calculates the error and propagates it based on the derivative of the loss function with respect to each network parameter. This is called the “backward propagation” phase.

For example, let ƒ(x) be an arbitrary activation function:

ƒ(xⱼ)=Σᵢ₌₁^{N}wᵢⱼxᵢ+bⱼ (1)

where N is the number of inputs, and i and j are the indexes of the weights from the input features. As the input of ƒ is dependent on the previous layers as each ƒ has the inputs from the output of the previous layer:

x=gᵢ₋₁(xᵢ₋₁) (2)

where g is another activation function similar to ƒ. Therefore:

ƒ(x)=ƒ(gᵢ₋₁(xᵢ₋₁)) (3)

Variance will be defined as below:

$${σ}^{2} = \frac{{\sum }_{i = 1}^{n} {( {x}_{i} - \overline{x} )}^{2}}{n} \qquad ( 4 )$$

And as x is the equivalent of each activation function in the layer, Variance can be re-defined as below:

$${σ}^{2} = \frac{{\sum }_{i = 1}^{n} {( f ( {x}_{i} ) avg ( f ( {x}_{i} ) ) )}^{2}}{n} \qquad ( 5 )$$

Thus, it is shown that the variance of the actitation functions at each layer is the equivalent of sensitivity of the layer to the input.

At this step, a null hypothesis can be made in the following way:

Hypothesis 1—Change in the Input Features does not Affect the Sensitivity in the Intermediary Layers.

In order to refute the hypothesis, the Analysis of Variance (ANOVA) is used to study if the change in the input feature has an effect on the sensitivity of the neural network.

Most methods previously used for Neural Networks relied on perturbing the input data and measuring the resulting output from the network. Concretely, this means that each feature in the input of the network is changed so much that it does not have any of its original characteristic. Measurement is then made of how important that feature provides to the output of the network. Recent methods, on the other hand, measure the sensitivity of the Neural Network to features based on a gradient.

The method and systems in accordance with the present embodiments breaks with both of these prior approaches. In accordance with the present embodiments, it is proposed to calculate the importance a feature gives to the output of the network via a statistical analysis of the activation functions. The activation functions are seen simply as non-linearities in the neural network. The outputs of these non-linearities are important as they lead the input features to the output at the time of inference, alongside the weights and biases previously defined.

Following the use in statistics, the problem of explainability can be defined as a null hypothesis stating that:

Hypothesis 2—Changing a Feature in the Input does not Change the Output of the Activation Function.

This way, the variance created by the perturbation on the activation function outputs can be studied. The easiest method to study this variance would be one-way ANOVA, which is a very popular statistical calculation to accept or refute a hypothesis.

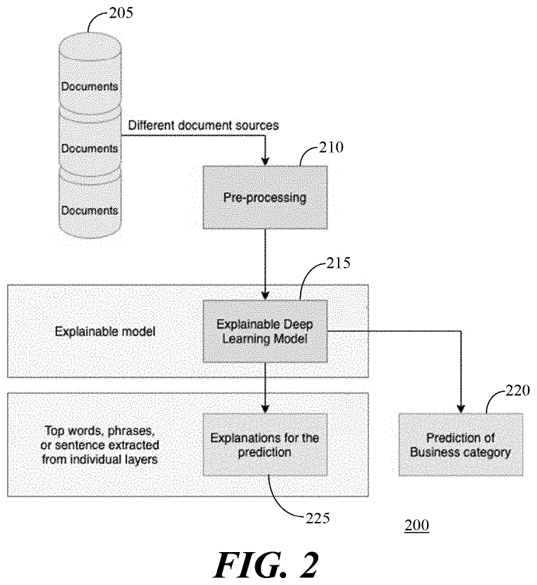

Referring to FIG. 2, a block diagram 200 depicts a software system for artificial explainability in accordance with present embodiments. An input source 205 of the software system receives structured (textual) documents, semi-structured (textual) documents or unstructured (textual) documents from multiple data sources. Once the input is ingested, each document will go through a simple pre-processing 210 such as data cleaning to detect the words, phrases, and sentences inside the document. Next, an artificial neural network, such as a Deep Learning model 215, is used to calculate the importance of a feature in accordance with the present embodiments by statistical analysis of the activation function to predict a business category 220 of the document. In accordance with the systems and methods of the present embodiments, the Neural Network model is fully explainable and can be scrutinized by the end user at any time for any predictions it makes. The explanations are fully comprehensible by the end user and can be used to detect model failure or to perform model verification. If the user does not trust the model at any point, they can ask for explanations 225 which will be generated instantly by the model. The explanation 225 extract top words, phrases or sentences (such as Manager. CV, Phone, Position). Utilizing the explanation 225, the user builds trust with the software—and subsequently the model. The generated explanations 225 can either be single words, phrases, or sentences based on the user's choice.

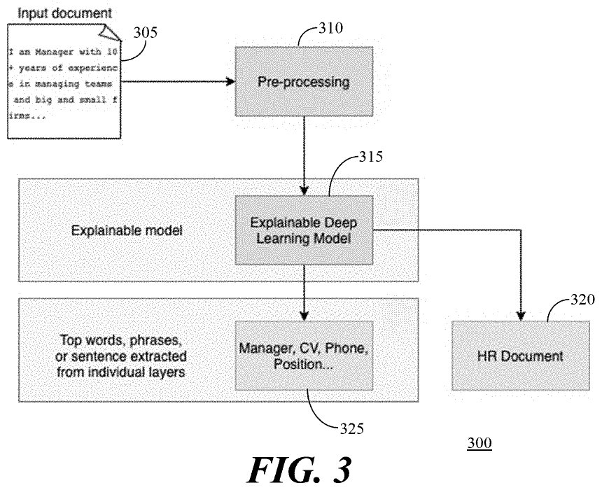

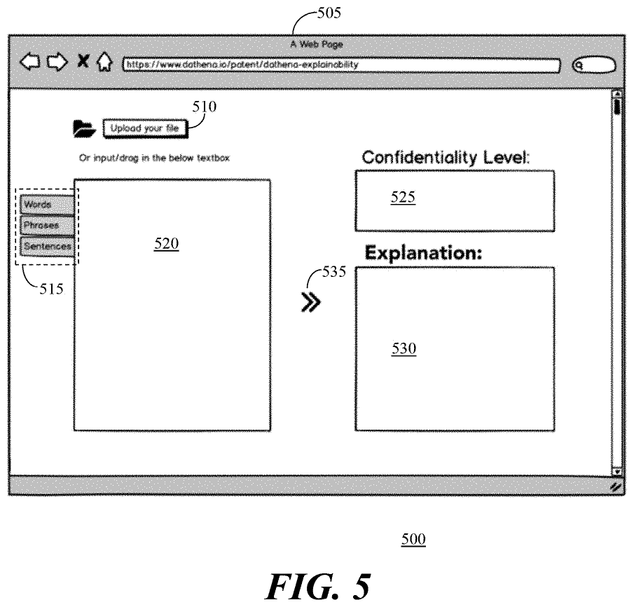

There are to use cases for the systems and methods in accordance with the present embodiments: Targeted classification, and Pipeline classification. Referring to FIG. 3, a block diagram 300 depicts a software system for targeted classification including AI explainability in accordance with the present embodiments. A document 305 document goes through pre-processing 310 and fed to an explainable Deep Learning model 315 which calculates the importance of a feature in accordance with the present embodiments by statistical analysis of the activation function to predict whether the document is a human resources (HR) document 320. In accordance with the present embodiments, the Deep Learning model 315 is fully explainable and can be scrutinized be the end user at any time for any predictions it makes. The end user can scrutinize the Deep Learning model 315 be reviewing explanations 225 which will be generated instantly by the model. The explanation 225 extract top words, phrases or sentences (such as Manager, CV, Phone, Position). Utilizing the explanation 325 of top words, phrases or sentences extracted from individual layers based on the user's choice.

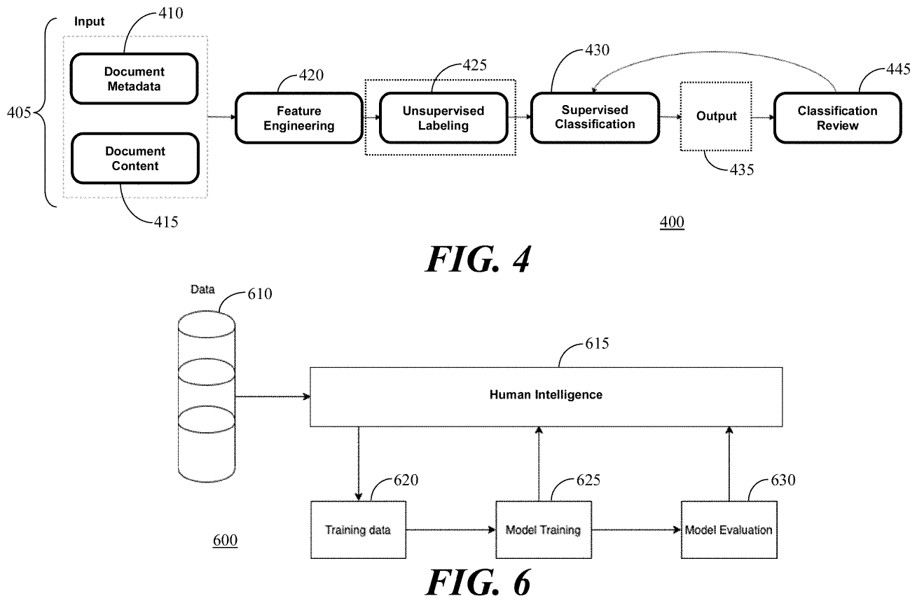

Referring to FIG. 4, a block diagram 400 depicts a pipeline artificial neural network system 405 which incorporates Pipeline classification including AI explainability in accordance with the present embodiments. The pipeline artificial neural network system 405 begins with a document metadata input 410 and a document content input 415. After input 410, 415, vectorization of the document metadata and content occurs at feature engineering 420. Unsupervised labelling 425 is performed by propriety autolabelling software. Then, in accordance with the present embodiments, explainable supervised document classification 430 occurs followed by output 435 of probabilities of the classifier. A user interface 440 enables the user to interact with the explanations and classification outputs in accordance with the present embodiments and review the results.

Referring to FIG. 5, an illustration 500 depicts a user interface 505 for standalone targeted classification software in accordance with the present embodiments. The user interface 505 has an input tab 510 which allows a user to upload or paste a document for metadata and content extraction and classification by a standalone Artificial Neural Network in accordance with the present embodiments. A user can then select by tabs 515 the type of explanations the user wishes to obtain such as words, phrases or sentences.

In addition to uploading the file using the tab 510, the user is able to drag the document to a field 520 for document input. Not that when the user inputs the document via the field 520, the user is unable to make use of the document metadata for the classification. The output of the classification task will be presented in the field 525 which will indicate the confidentiality or business category of the document (or the results of any other classification task) and in the field 530 which will present the explanations of the classification task regarding the document, which could be one of words, phrases, or sentences. A forward button 535 is used to initiate the classification process.

In the targeted classification, utilizing the user interface 505, the user will target one document and get the output from the software for the specific document. For the targeted classification, users can input a document by uploading the document file by the button 510 or b % pasting the document content in the field 520. Using the document upload button 510, the software will e-tract all the document metadata and the document content. In comparison, when the user chooses to only paste the document in the field 520, the software has only access to the document content and, therefore, cannot use metadata features as input to the model.

The user will next click on the type of explanations 515 they want. The choices are words, phrases, and sentences. Words are single tokens such as “Private” or “Confidential”. Phrases are multiple words that come together such as “Do not share”. Lastly, a sentence refers to a set of words that end with a period, exclamation mark, or question mark. An example is “Please do not share this document.”

After the selection of the types of explanations 515, the user will click on the forward button 535. The document will be read, pre-processed, and cleaned and then fed to the Artificial Neural Network. This Artificial Neural Network will then predict the class that the document belongs to. This class can be either the business category of the document or its confidentiality. At the time of predicting the class, another process continues to explain the important features that the model is sensitive to. These features will be shown in the explanation field 530 of the user interface 505.

After this step the confidentiality level and/or the business category will be shown in the related field 525. This way the user will understand the prediction of the model as well as the reasons (i.e., the important features) behind the choice.

For the pipeline classification, as shown in the pipeline system 405, the document is stored on the server or on the cloud. The software will input the document's metadata 410 and content 415 and actively look for the documents and predict their corresponding category and confidentiality 430. In this method, the user's interaction with the software is only running the pipeline and, in accordance with the present embodiments, classification review 445. The rest of the operation will be done automatically, and the documents' business category and confidentiality will be reported automatically.

Thus, it can be seen that systems and methods in accordance with the present embodiments enable users of to understand the reason behind why the AI/Artificial Neural Network has chosen a specific category. A successful explanation is one that is understandable to the end user. As hereinafter shown, the explanations outputted in accordance with the present embodiments are understandable by the user and thus the systems and methods in accordance with the present embodiments have been successfully demonstrated.

Referring to FIG. 6, a block diagram 600 depicts a system and method for model training and model evaluation in accordance with the present embodiments with a human in the loop. Input data 610 includes documents from multiple data sources. In accordance with the present embodiments, a human reviewer 615 serves as a controller and validator of the Artificial Intelligence. Under the control of the human reviewer, documents or excerpts from the input data 610 are provided as training data 620 and is used to train the Artificial Neural Network. The explainable model training 625 in accordance with the present embodiments provides explanations to the human reviewer 615 as described hereinabove and enables model evaluation 630 for fully explainable artificial intelligence in accordance with the present embodiments.

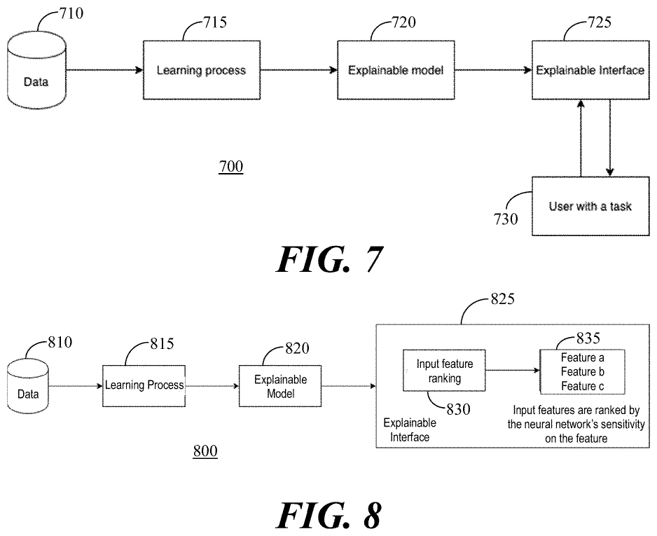

FIG. 7 depicts a block diagram 700 of an exemplary general architecture of explainable machine learning software in accordance with the present embodiments. Input documents from multiple data sources 710 here (though only one data source 710 has been illustrated) is fed to a learning process 715 which is a training phase of the Artificial Neural Network. The fully explainable model 720 in accordance with the present embodiments processes the training data from the learning process 715 and provides results and receives commands from a user interface serving as an explainable interface 725, such as the user interface 505. A human evaluator 730 of the model reviews the explanations and the output provided by the explainable interface 725 to interact with the explanations and review the output.

Referring to FIG. 8, a block diagram 800 depicts the general architecture of explainable machine learning software in accordance with the present embodiments with architecture of an exemplary explainable interface. Input documents 810 are inputted from multiple data sources and provided to the learning process 815. Data from the learning process 815 is provided to the explainable model 820 in accordance with the present embodiments. The user interface (explainable interface 725) enables the user to interact with the explanations and review the output. At this stage the user can see top input features that have contributed to the decision that the Artificial Neural Network has taken as the input feature ranking 830 which can be displayed as ranked input features 835 ranked in accordance with the present embodiments by the neural network's sensitivity to the feature.

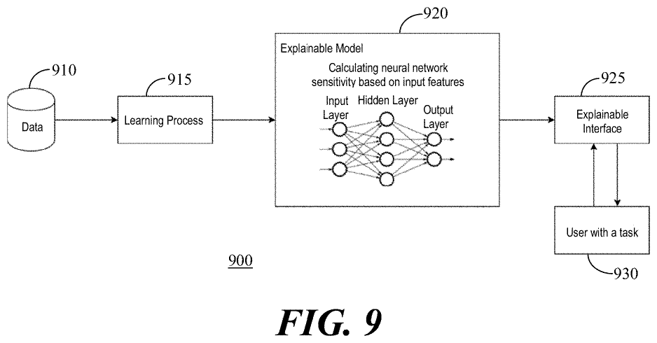

FIG. 9 depicts a block diagram 900 of the general architecture of the explainable machine learning software in accordance with the present embodiments with architecture of an explainable model 920 in accordance with the present embodiments. Input documents 910 are inputted from multiple data sources and provided to the learning process 915. Data from the learning process 915 is provided to the explainable model 920 in accordance with the present embodiments. The explainable model 920 calculates the sensitivity of the Artificial Neural Network based on the variance of the activation functions. A user interface serving as an explainable interface 925 receives explanations and output, and a human evaluator 930 of the model with a task reviews the explanations and the output provided by the explainable interface 925 to interact with the explanations and review the output.

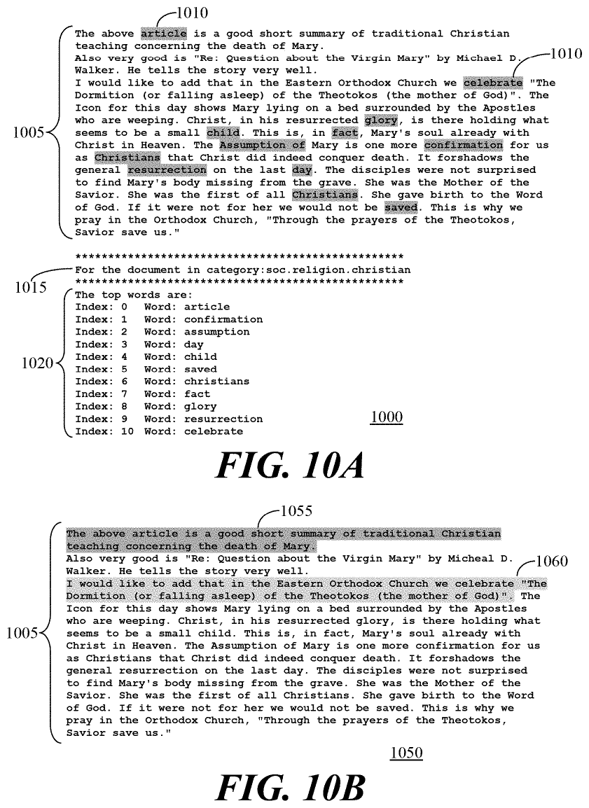

Referring to FIGS. 10A and 10B, illustrations 1000, 1050 depict sampling of text using one-hot encoding in accordance with the present embodiments. The illustration 1000 (FIG. 10A) depicts results from explanation of keywords 1010 highlighted in a text 1005. The keywords are identified in the text 1005 using a label to identify Christian words. The text 1005 is selected from the category 1015 “soc.religion.christian”. In accordance with the present embodiments, the highlighted keywords 1010 are ranked in order of importance in explanations 1020 extracted from the artificial neural network software.

After generating and highlighting the top keywords 1010, it is evident that it would make more sense to present whole sentences containing those words instead of the words alone. This is shown in the illustration 1050 (FIG. 10B) which is explanation uses a label to identify sentences under the category Christian. To do so, all top keywords may be used to reach the outcome of the illustration 1050. However, the top sentence 1055 and the second-to-top sentence 1060 do not contain all the important words. No occurrence of the top ten words in a single sentence does not mean that the sentence is not valid. This is a reasonable result, since all the top words were used to find sentences that are most informative about the topic.

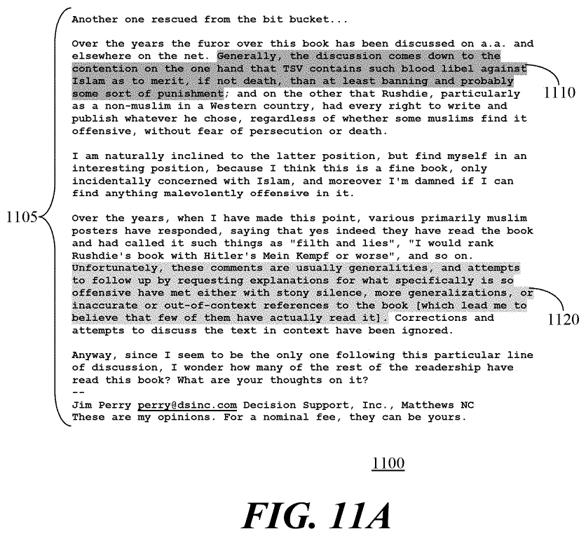

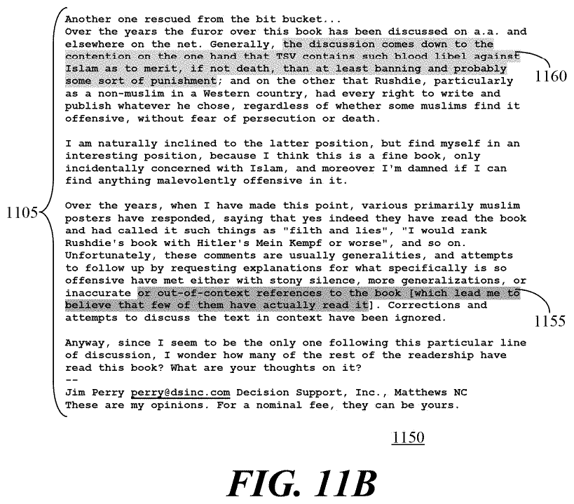

FIGS. 11A and 11B depict illustrations 1100, 1150 of sampling of a second text 1105 using one-hot encoding in accordance with the present embodiments. The illustration 1100 (FIG. 11A) depicts results from explanation of a top sentence 1110 and a second-to-top sentence 1120 highlighted in the second text 1105 in accordance with the present embodiments.

It was noted in the highlighted sentences 1110, 1120 that the results have a bias towards long sentences as they are more likely to contain all words. With this in mind, it was decided to extract phrases which separate the context not only by using “!”, “?”, “.”, “;”, but also by using “,”. This is shown in the illustration 1150 (FIG. 11B) where the top phrase 1155 and the second-to-top phrase 1160 are highlighted. The results, however, showed that the issue of favoring longer phrases/sentences still exists and needs to be addressed using a different technique.

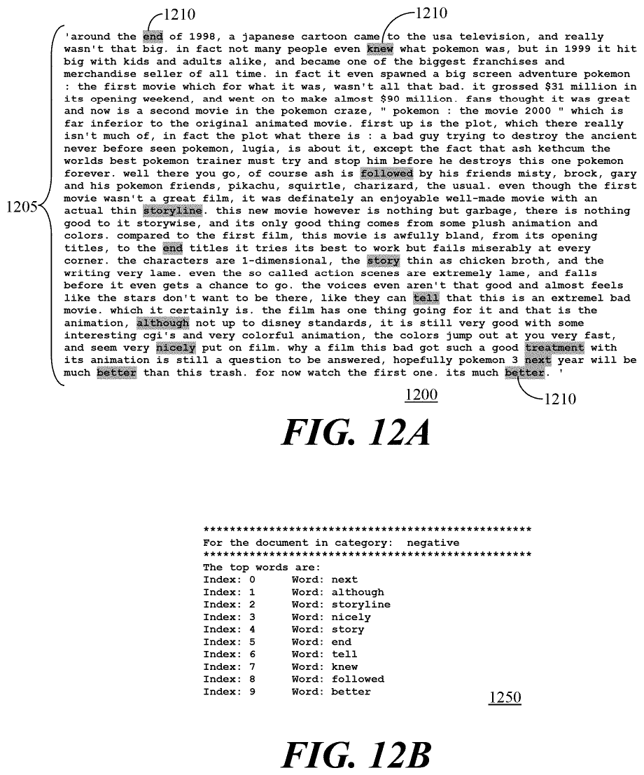

Referring to FIGS. 12A and 12B, illustrations 1200, 1250 depict sampling of a third text sample 1205 using one-hot encoding in accordance with the present embodiments. The illustration 1200 (FIG. 12A) depicts results from explanation of keywords 1210 highlighted in the third text 1205. The keywords 1210 are identified in the text 1005 using a label to identify negative words. In accordance with the present embodiments, the highlighted keywords 1210 are ranked in order of importance in explanations extracted from the artificial neural network software as shown in the illustration 1250 (FIG. 12B).

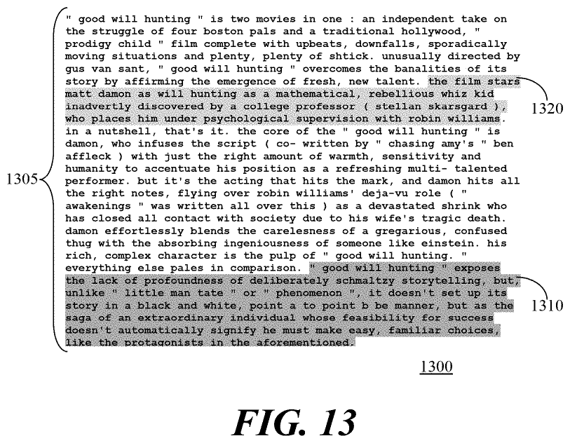

FIG. 13 depicts an illustration 1300 of sampling of a fourth text 1305 to identify sentences based on word occurrences using one-hot encoding in accordance with the present embodiments. A top rated sentence 1310 and a second-to-top rated sentence 1320 rated for a positive label in accordance with the present embodiments are highlighted in the fourth text 1305.

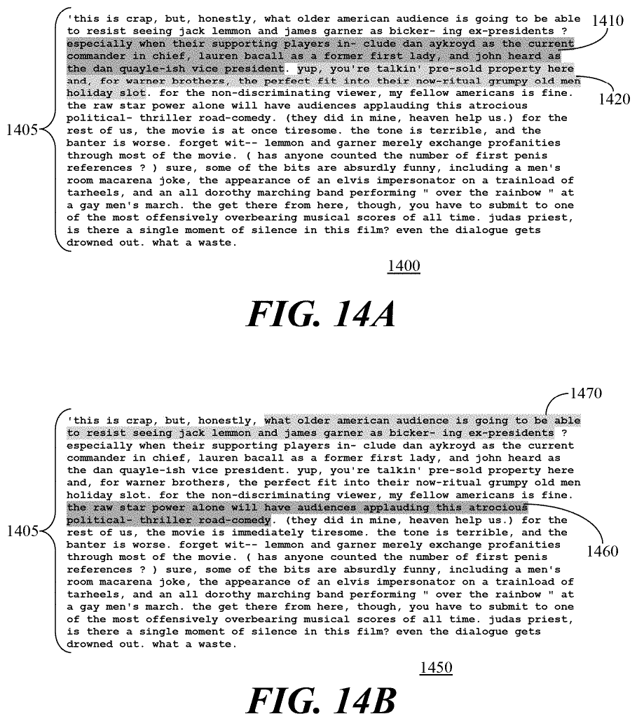

FIGS. 14A and 14B depict illustrations 1400, 1450 of sampling of a fifth text 1405 using one-hot encoding in accordance with the present embodiments. The illustration 1400 (FIG. 14A) depicts results from explanation of a top sentence 1410 and a second-to-top sentence 1420 highlighted in the fifth text 1405 in accordance with the present embodiments. The illustration 1450 (FIG. 14B) depict extracting phrases which separate the context in the fifth text 1405, where the top phrase 1460 and the second-to-top phrase 1470 are highlighted.

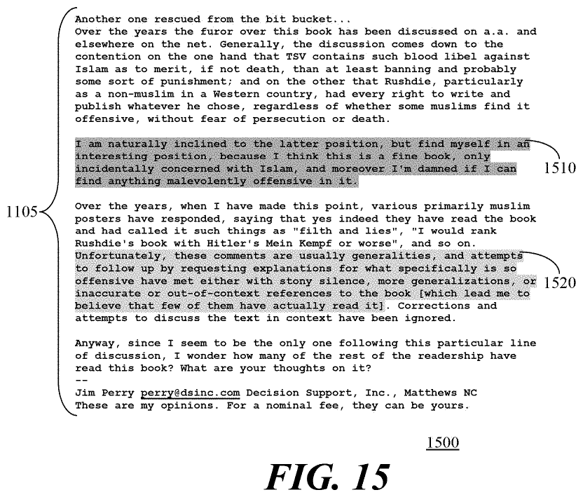

FIG. 15 depicts an illustration 1500 of the second text 1150 sampled by Sent2Vec, an unsupervised model for learning general-purpose sentence embeddings, in accordance with the present embodiments. The top ranked sentence 1510 and the second-to-top ranked sentence 1520 are the top sentences of the second text which is a correctly predicted document for the label atheism.

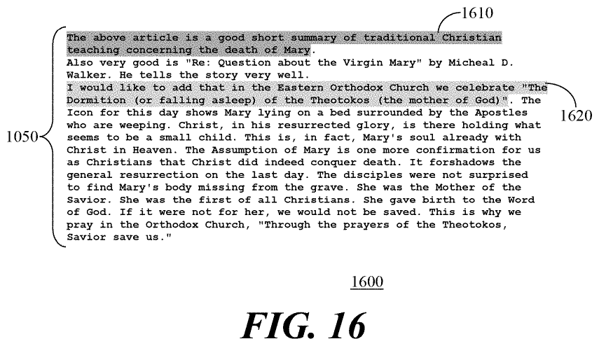

However, when the first text 1050 is sampled by Sent2Vec in accordance with the present embodiments, the label is incorrectly predicted. FIG. 16 depicts an illustration 1600 of the first text 1050 sampled by Sent2Vec in accordance with the present embodiments. The top ranked sentence 1610 and the second-to-top ranked sentence 1620 are the top sentences of the second text. The predicted label is “talk.religion.misc”. However, the correct label for the first text 1050 is “soc.religion.christian”.

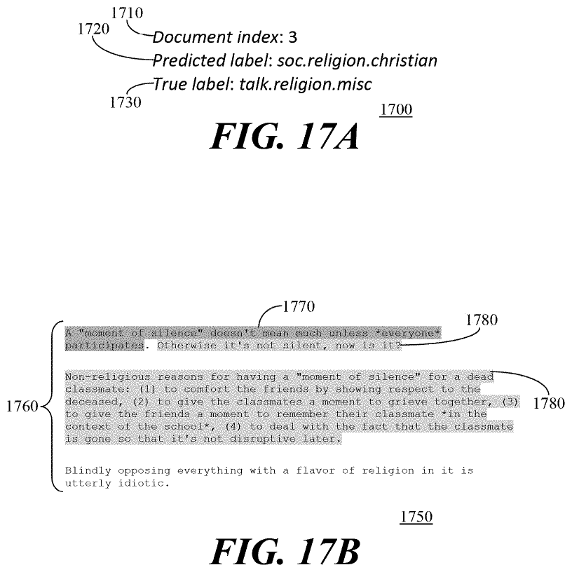

FIGS. 17A/17B, 18A/18B and 19A/19B depict multiple edge cases for label prediction that were identified and observed. Referring to FIGS. 17A and 17B, illustrations 1700, 1750 depict a first edge case in accordance with the present embodiments. The illustration 1700 depicts an index number 1710, a predicted label 1720 and a correct label 1730 for the first edge case. The illustration 1750 depicts text 1760 for the first edge case with a top ranked sentence 1770 and second-to-top ranked sentences 1780 highlighted. While the lapel was incorrectly predicted, it is noted that even a human would have difficulty categorizing the text 1760.

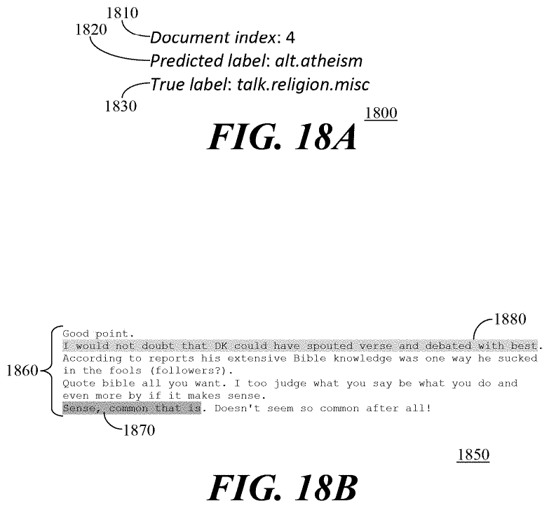

Referring to FIGS. 18A and 18B, illustrations 1800, 1850 depict a second edge case in accordance with the present embodiments. The illustration 1800 depicts an index number 1810, a predicted label 1820 and a correct label 1830 for the second edge case. The illustration 1850 depicts text 1860 for the second edge case with a top ranked sentence 1870 and a second-to-top ranked sentence 1880 highlighted. The incorrect prediction appears to be mainly caused by the model picking the top ranged sentence 1870 incorrectly. However, it is unclear whether any information can be found in the sentences 1870, 1880 to help the model make a correct prediction.

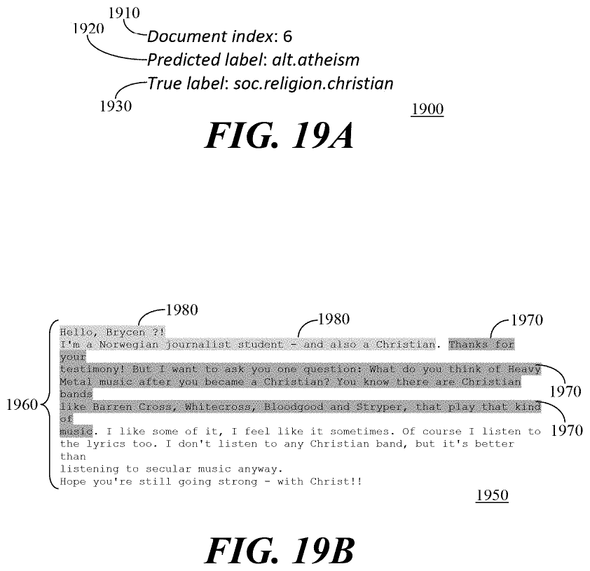

Referring to FIGS. 19A and 19B, illustrations 1900, 1950 depict a third edge case in accordance with the present embodiments. The illustration 1900 depicts an index number 1910, a predicted label 1920 and a correct label 1930 for the third edge case. The illustration 1950 depicts text 1960 for the third edge case with top ranked sentences 1970 and second-to-top ranked sentences 1980 highlighted.

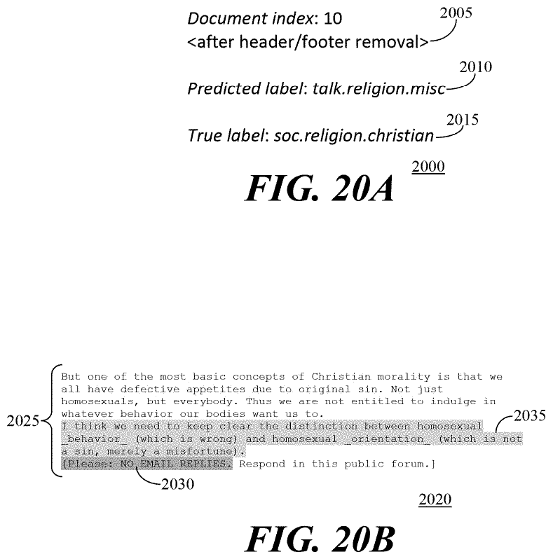

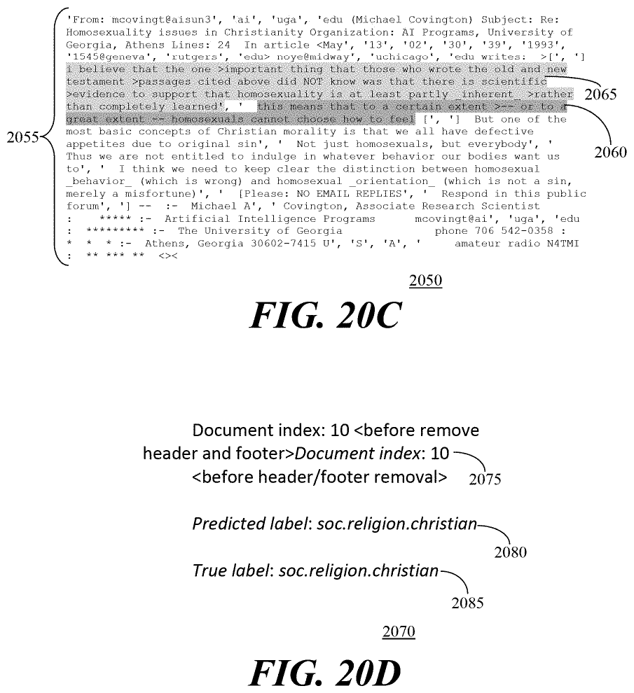

It has been found that the average accuracy on a normal deep learning model using one-hot encoding with these three classes is around 60%˜70%. After adding the header, the footer and the quotes back in the original text, the accuracy of the Sent2Vec model is around 60% with an F1 score of 0.6 for the datasets reviewed. Moreover, the top sentences do not change much using this the Sent2Vec model with or without the header, the footer and the quotes in the original text. The improved accuracy with and without headers, footers and quotes can be seen in a comparison of FIGS. 20A/20B and FIGS. 20C/20D, as well as the little change in the top sentences with and without headers, footers and quotes.

Referring to FIGS. 20A and 20B, illustrations 2000, 2020, 205, 2070 depict exemplary text with and without headers, footers and quotes in accordance with the present embodiments. The illustration 2000 depicts an index number 2005, a predicted label 2010 and a correct label 2015 for the exemplary text without headers, footers and quotes. The predicted label 2010 is “talk.religion.misc” while the correct label 2015 is “soc.religion.christian”. The illustration 2020 depicts text 2025 for the exemplary case without headers, footers and quotes and with a top ranked sentence 2030 and a second-to-top ranked sentence 2035 highlighted. The illustration 2050 depicts text 2055 for the exemplary case adding in the headers, footers and quotes and with a top ranked sentence 2060 and a second-to-top ranked sentence 2065 highlighted. Note that other than the added back header, footer and quotes, the top ranked sentence 2060 and the second-to-top ranked sentence 2065 are the same as top ranked sentence 2030 and a second-to-top ranked sentence 2035 of the illustration 2020.

The illustration 2070 depicts an index number 2075, a predicted label 2080 and a correct label 2085 for the exemplary text with the headers, footers and quotes. The predicted label 2080 is “soc.religion.christian”, the same as the correct label 2015 is “soc.religion.christian”. The illustrations 2000, 2020, 2050, 2070 show the influence of the header and footer presence on the top sentences picked by the model as well as on the accuracy of the predicted label. This demonstrates that the context becomes more informative when adding the header and footer, and even that the top sentences can be picked from the header or the footer as well.

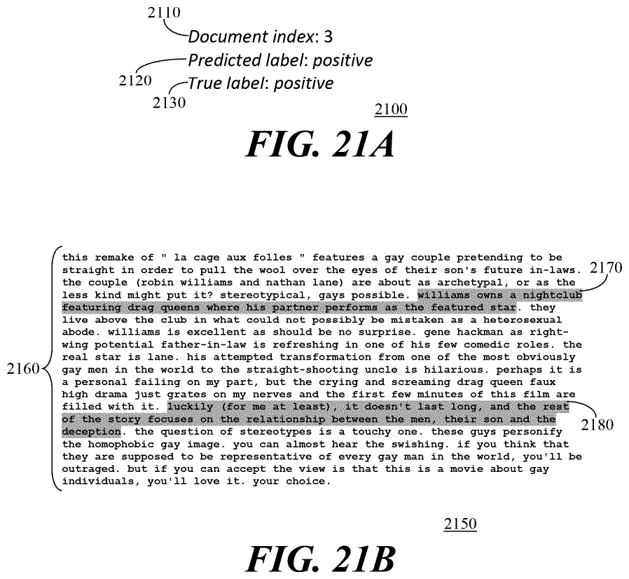

Referring to FIGS. 21A and 21B, illustrations 2100, 2105 depict sampled by Sent2Vec in accordance with present embodiments of an exemplary text dataset of positive and negative movie reviews from Cornell Natural Language Processing. The classification of text from this dataset has an accuracy of 78% and an F1 score of 0.785. Further, the selected sentences are clear and informative.

The illustration 2100 depicts a document index number 2110, a predicted label 2120 and a correct label 2130 for the exemplary text. The illustration 2150 depicts the exemplary text 2160 with a top ranked sentences 2170, 2180 highlighted. It is noted that the predicted label 2120 matches the correct label 2130 evidencing the high accuracy of the artificial neural network to classify these datasets in accordance with the present embodiment.

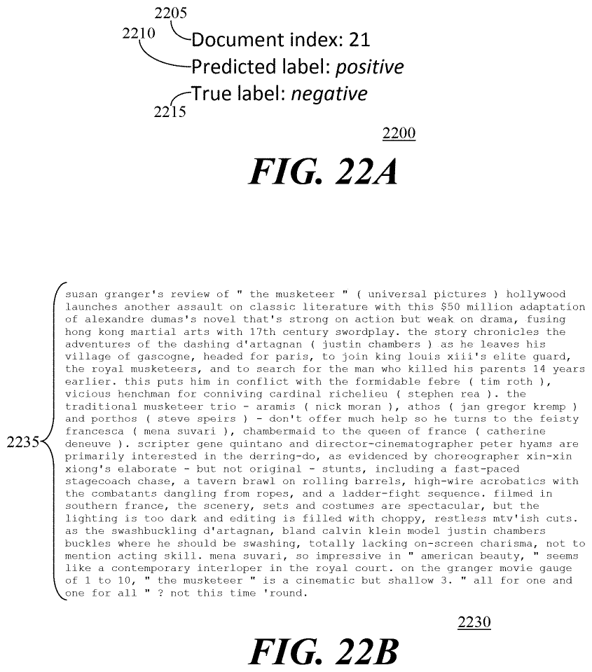

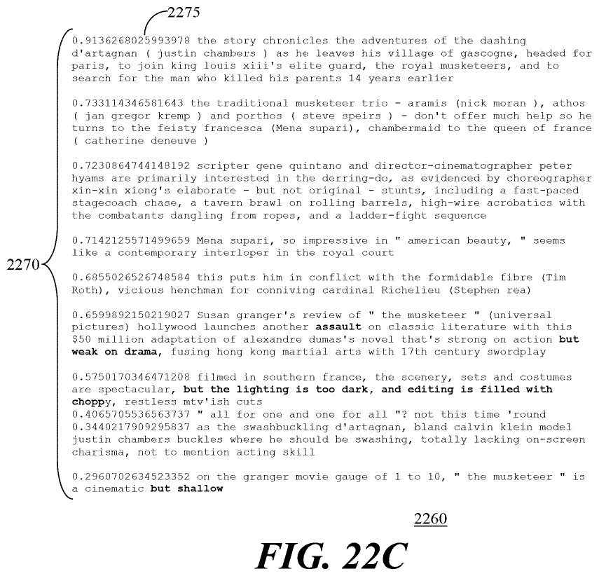

A first document and a second document representing first and second edge cases from the dataset of positive and negative movie reviews from Cornell Natural Language Processing are further examined. The first and second documents show how the ranking of important sentences affects the prediction: after human inspection, it appears that the most informative sentences are ranked lower, which means the prediction model didn't capture the document's critical information well. FIGS. 22A, 22B and 22C depict illustrations 2200, 2230, 2260 representing further examination of a first edge case from the dataset of positive and negative movie reviews from the Cornell Natural Language Processing sampled by Sent2Vec in accordance with present embodiments. The illustration 2200 depicts a document index number 2205, a predicted label 2210 and a correct label 2215 for the first edge case. The illustration 2230 depicts text 2235 of the first edge case, and the illustration 2260 depicts prediction of important sentences 2270 in the text of the first edge case. The number 2275 before each prediction shows the significance of that prediction. As can be seen, there is not much confidence for the top predictions. And, accordingly, the predicted label 2210 is “positive”, while the correct label 2215 is “negative”.

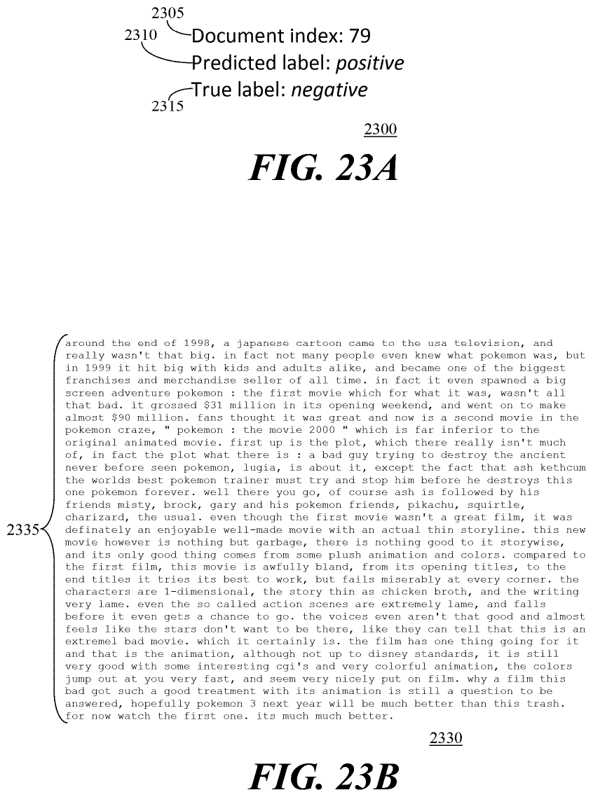

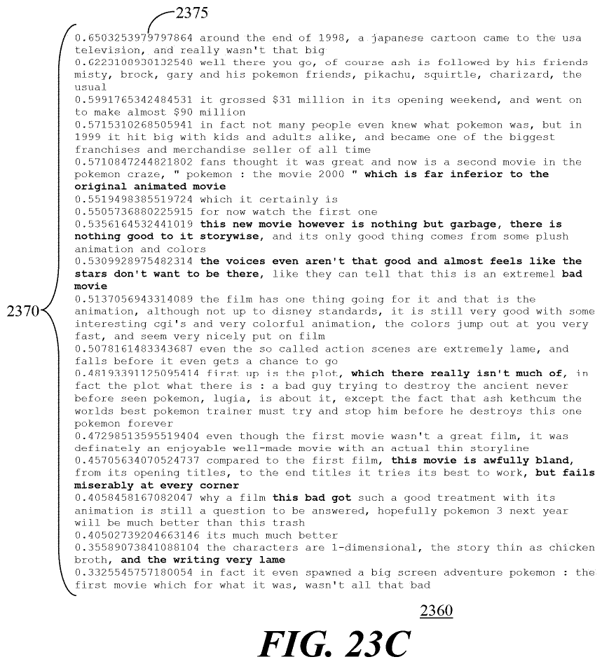

FIGS. 23A, 23B and 23C depict illustrations 2300, 2330, 2360 representing further examination of a second edge case from the dataset of positive and negative movie reviews from the Cornell Natural Language Processing sampled by Sent2Vec in accordance with present embodiments. The illustration 2300 depicts a document index number 2305, a predicted label 2310 and a correct label 2315 for the second edge case. The illustration 2330 depicts text 2335 of the second edge case, and the illustration 2360 depicts prediction of important sentences 2370 in the text of the first edge case. The number 2375 before each prediction shows the significance of that prediction. As can be seen, there is also not much confidence for the top predictions in the second edge case and the predicted label 2310 is “positive”, while the correct label 2315 is “negative”.

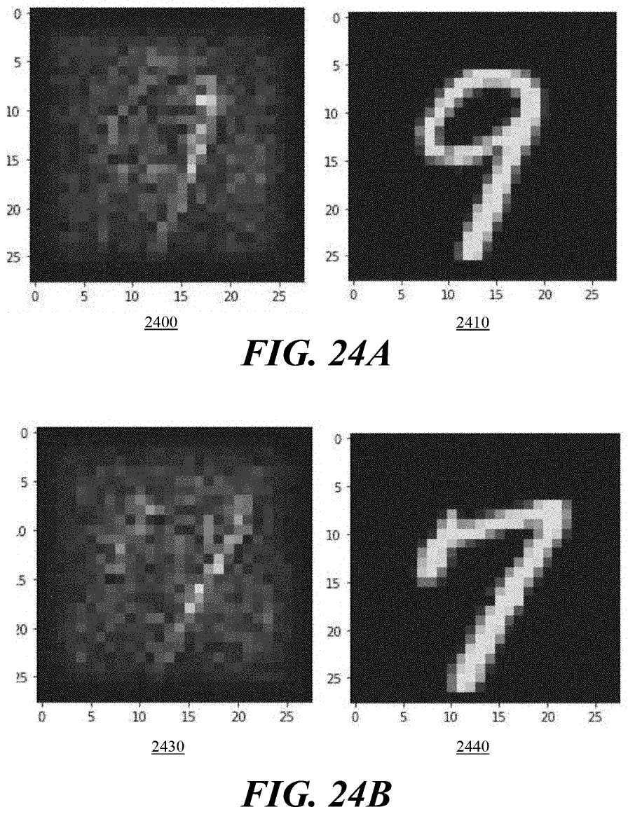

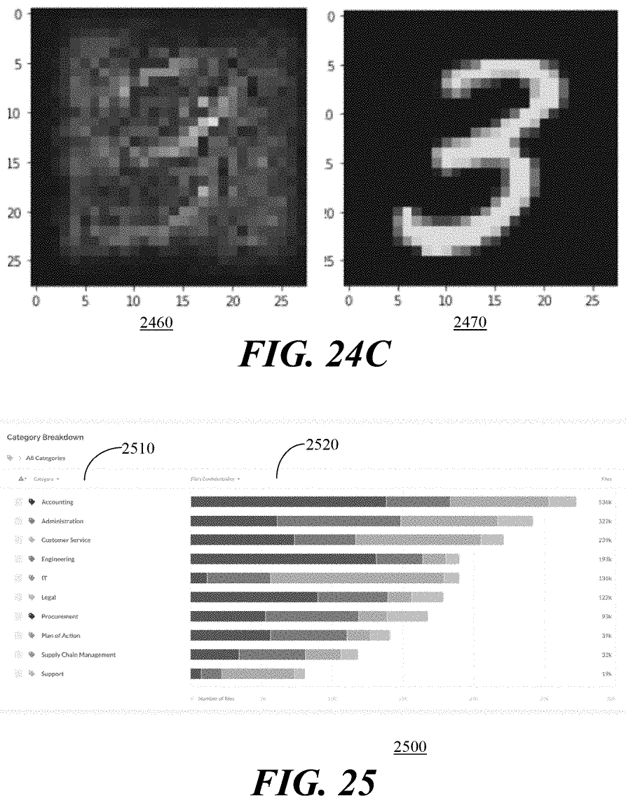

In addition to text, an explanation of an image can also be presented to the user which would be based on using the activation function of a node which defines an output of a node in the neural network given a set of inputs as a measure of sensitivity to determine important features in the image that the model is sensitive to. Referring to FIG. 24A, illustrations 2400, 2410 depict sample explanations of an image showing the number “9” based on measurements of the activation function outputs between two groups in accordance with the present embodiments. As seen in the illustration 2400, the more yellow the pixel in the original image (i.e., the illustration 2410), the more sensitive the pixel is.

Referring to FIGS. 24B and 24C, illustrations 2430, 2440 and illustrations 2460, 2470 depict sample explanations of images showing the numbers “7” and “3”, respectively.

Referring to FIG. 25, a bar graph 2500 depicts the number of files in various business categories classified for confidentiality in accordance with the present embodiments. The business categories 2510 are along the righthand side and the bars 2520 depict the number of files that have been classified based on confidentiality in accordance with the present embodiments. As can be seen from the bar graph, the most confidential files are in Accounting. Engineering and Legal.

Thus, it can be seen that the present embodiments provide design and architecture for explainable artificial intelligence systems and methods which is adaptable to the vagaries of various artificial intelligent (AI) processes and enable the user to build confidence and trust in the operation of the AI processes. Whether in a standalone implementation or inserted into a data management pipeline, the present embodiments provide different methods for user explanation (e.g., by word, by phrase or by sentence) particularly suited for classification systems and methods which enable correction of predicted sentiment or classification during operation of the AI processes.

While exemplary embodiments have been presented in the foregoing detailed description of the disclosure, it should be appreciated that a vast number of variations exist. It should further be appreciated that the exemplary embodiments are only examples, and are not intended to limit the scope, applicability, operation, or configuration of the disclosure in any way. Rather, the foregoing detailed description will provide those skilled in the art with a convenient road map for implementing an exemplary embodiment of the disclosure, it being understood that various changes may be made in the function and arrangement of steps and method of operation described in the exemplary embodiment without departing from the scope of the disclosure as set forth in the appended claims.

What is claimed is:

1. A system for explainable artificial intelligence comprising:
a document input device;
a pre-processing device coupled to the document input device and configured to prepare information in documents for processing;
an artificial neural network coupled to the pre-processing device and configured to process the information for one or more tasks; and
a user interface device coupled to the artificial neural network and configured in operation to provide explanations and visualization to a user of the processing by the artificial neural network.

2. The system in accordance with claim 1 wherein the processing the information for the one or more tasks comprises calculating the importance of a feature of the information by statistical analysis of an activation function of the artificial neural network.

3. The system in accordance with claim 1 wherein the one or more tasks comprise textual data classification.

4. The system in accordance with claim 3 wherein the textual data classification comprises classification by one or more business categories.

5. The system in accordance with claim 3 wherein the textual data classification comprises classification by one or more confidentiality categories.

6. The system in accordance with claim 3 wherein the textual data classification comprises a prediction of textual data classification.

7. The system in accordance with claim 6 wherein the processing the information for one or more tasks comprises calculating the importance of a feature of the information by statistical analysis of an activation function of the artificial neural network to determine the prediction of textual data classification.

8. The system in accordance with claim 7 wherein the explanations and visualization to the user comprise explanations for the prediction of textual data classification.

9. The system in accordance with claim 8 wherein the explanations for the prediction of textual data classification comprise explanations using prioritized categorization of portions of the information processed for the prediction of textual data classification.

10. The system in accordance with claim 9 wherein the portions of the information comprise one of words, phrases or sentences.

11. The system in accordance with claim 1 wherein the artificial neural network comprises a deep learning model.

12. The system in accordance with claim 1 wherein the documents comprise one of structured documents, semi-structured documents or unstructured documents.

13. A method for explainable artificial intelligence comprising:
receiving a document;
pre-processing the document to prepare information in the document for processing;
processing the information by an artificial neural network for one or more tasks; and
during processing of the information by the artificial neural network, providing explanations and visualization of the processing by the artificial neural network to a user.

14. The method in accordance with claim 13 wherein the processing the information for the one or more tasks comprises calculating the importance of a feature of the information by statistical analysis of an activation function of the artificial neural network.

15. The method in accordance with claim 13 wherein the processing the information for the one or more tasks comprises textual data classification of the information.

16. The method in accordance with claim 15 wherein the textual data classification comprises a prediction of textual data classification into one or more business categories or one or more confidentiality categories.

17. The method in accordance with claim 16 wherein the explanations and visualization to the user comprise explanations for the prediction of textual data classification using prioritized categorization of portions of the information processed for the prediction of textual data classification.

18. The method in accordance with claim 17 wherein the portions of the information comprise one of words, phrases or sentences.

19. The method in accordance with claim 13 wherein the documents comprise one of structured documents, semi-structured documents or unstructured documents.

20. A non-transitory computer readable medium having instructions for performing explainable artificial intelligence stored thereon which when the instructions are provided to a processor, execution of the instructions cause the processor to:
receive a document;
process information in the document by an artificial neural network for one or more tasks; and
during processing of the information by the artificial neural network, provide explanations and visualization of the processing by the artificial neural network to a user.
